(19) United States
(12) Patent Application Publication
(10) Pub. No.: US 2026/0038790 A1
(43) Pub. Date: Feb. 5, 2026

(54) MONOLITHIC THREE-DIMENSIONAL ION TRAP

(71) Applicants: William Marsh Rice University, Houston, TX (US); Duke University, Durham, NC (US); Translume, Inc., Ann Arbor, MI (US)

(72) Inventors: Guido Pagano, Houston, TX (US); Roman Zhuravel, Houston, TX (US); Norbert Matthias Linke, Durham, NC (US); Visal So, Houston, TX (US); Midhuna Duraisamy Suganthi, Houston, TX (US); Abhishek Menon, Houston, TX (US); April Sheffield, Houston, TX (US); Henry De Luo, Durham, NC (US); Michael W. Straus, Durham, NC (US); Mark Dugan, Ann Arbor, MI (US)

(73) Assignees: William Marsh Rice University, Houston, TX (US); Duke University, Durham, NC (US); Translume, Inc., Ann Arbor, MI (US)

(21) Appl. No.: 18/732,421

(22) Filed: Jun. 3, 2024

Related U.S. Application Data
(60) Provisional application No. 63/471,173, filed on Jun. 5, 2023.

(51) Int. Cl. H01J 49/42

(52) U.S. Cl. CPC H01J 49/424

(57) ABSTRACT

An ion trap apparatus includes a three-dimensional, monolithic segmented blade trap with high optical access along four orthogonal directions. The blade trap includes a plurality of blades. Each blade includes a glass material and a metal coating. Each blade is divided into a plurality of segments.

### CROSS REFERENCE TO RELATED APPLICATIONS

This application claims priority to U.S. Provisional Application Ser. No. 63/471, 173, filed on Jun. 5, 2023, entitled “Monolithic Three-Dimensional Ion Trap,” hereby incorporated herein by reference.

### STATEMENT REGARDING FEDERALLY SPONSORED RESEARCH

This invention was made with government support under Grant Nos. W911NF21P0003 and W911NF22C0012 awarded by the U.S. Army Corps of Engineers, and Grant No. W911QX21C0031 awarded by the Army Research Laboratory. The government has certain rights in the invention.

### BACKGROUND

Ion trapping is an attractive solution for applications that require the use of ion qubits. Planar traps (“chip traps”) and 3D traps may be used for the trapping of ions. Chip traps are a common parallel technology capable of effectively trapping ions. They have many advantages and disadvantages, and they are widely used for quantum computing applications. Three-dimensional ion traps offer different geometries, can be composed of separate parts, that are made from different materials using different manufacturing processes, and therefore, always require non-trivial assembly and alignment steps, which results in worse accuracy.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general embodiments disclosed herein relate to an ion trap apparatus that includes a three-dimensional, monolithic segmented blade trap with high optical access along four orthogonal directions. The blade trap includes a plurality of blades. Each blade includes a glass material and a metal coating. Each blade is divided into a plurality of segments.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 illustrates the ion trap apparatus in accordance with one or more embodiments.

FIG. 2 illustrates an ion trap apparatus in accordance with one or more embodiments.

FIG. 3A illustrates a segmented blade design in accordance with one or more embodiments.

FIG. 3B illustrates a cross-sectional view of the ion trap in accordance with one or more embodiments.

FIG. 3C illustrates a cross-sectional view of the ion trap trenches in accordance with one or more embodiments.

FIG. 3D illustrates an on-side view of the ion trap and its numerical apertures in accordance with one or more embodiments.

FIG. 3E illustrates small numerical apertures with diagonals of up to 45° in the trap plane in accordance with one or more embodiments.

FIG. 4 shows a method in accordance with one or more embodiments.

FIGS. 5 illustrates thermal imaging of the assembled ions traps presented in Example 1.

FIG. 6 illustrates a surface charge distribution of the ion trap presented in Example 1.

FIG. 7A illustrates an image of a chain of ions in the monolithic trap of Example 2.

FIGS. 7B-7C illustrate axial and radial frequency characterization of the ion trap presented in Example 2.

FIGS. 8A-8B illustrate the electrical and axial field potentials of the ion trap presented in Example 3.

FIG. 9A illustrates the electric potential and field lines of the ion trap presented in Example 3.

FIG. 9B illustrates the surface charge distribution of the ion trap presented in Example 3.

FIG. 10 shows the chains of up to ˜50 Yb⁺ ions trapped with the ion trap of Example 4.

FIG. 11A shows the transverse trap frequencies of the ion trap presented in Example 5.

FIG. 11B shows the excess micromotion determined by photon-correlation spectroscopy of the ion trap in Example 5.

FIGS. 11C-11D show the heating rates for a given time at various positions relative to the trap center described in Example 5.

### DETAILED DESCRIPTION

In one aspect, embodiments disclosed herein relate to a compact monolithic three-dimensional (3D) ion blade trap manufactured from a single piece of glass material.

A monolithic segmented blade trap is a significant advancement of the “standard” blade traps, which are built out of many small parts of various materials. Alignment of these small parts, especially the alignment of the blades, to the accuracy required is challenging. In comparison the monolithic approach offers much better dimensional accuracy (by eliminating the need for manual alignment), a more compact structure (by eliminating fasteners), and much better repeatability. Standard hand-assembled blade traps being made of a multitude of parts and/or materials, are also susceptible to drift when exposed to temperature cycles, an issue that is eliminated with the monolithic approach. The monolithic trap design is very versatile and can be integrated in a large variety of ion trapping systems including but not limited to quantum simulations, quantum information and quantum computing, quantum sensing, quantum communication and any other application that requires stable ions that are well insulated from the environment. Thus, this device could be used for the trapping of ions and/or charged nanoparticles in linear crystals (chains) for a variety of purposes.

Embodiments of the present disclosure relate to an ion trap apparatus of one or more embodiments is a 3D monolithic ion trap with a segmented blade configuration and high optical access along four directions. Furthermore, the present ion trap is a linear trap, and it is designed for trapping chains of ions. However, modified versions of the trap may be used for 2- and 3-dimensional ion formations. Compared to many planar traps (“chip traps”), the number of electrodes is lower which potentially limits the available controls. This may be overcome by allowing multiple zones and larger number of electrodes while retaining the basic advantages of 3D traps (lower heating rate, higher resilience to stray electric fields). One or more embodiments relate to a monolithic blade ion trap composed of single piece of glass material.

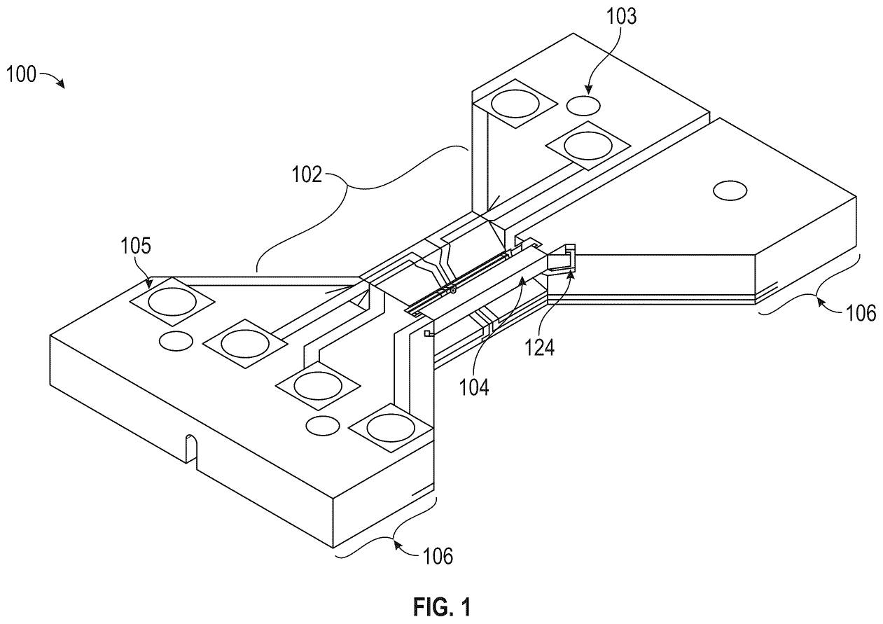

FIG. 1 illustrates the ion trap design in accordance with one or more embodiments. The ion trap design is a 3D structure that includes four segmented blades 104, that form the ion trap 102, and a surrounding structure 106 that provides mechanical support with mounting holes 103, thermal and electrical interface with the electrical contact pads 105 and trenches 124. All these parts form a single monolithic structure 100.

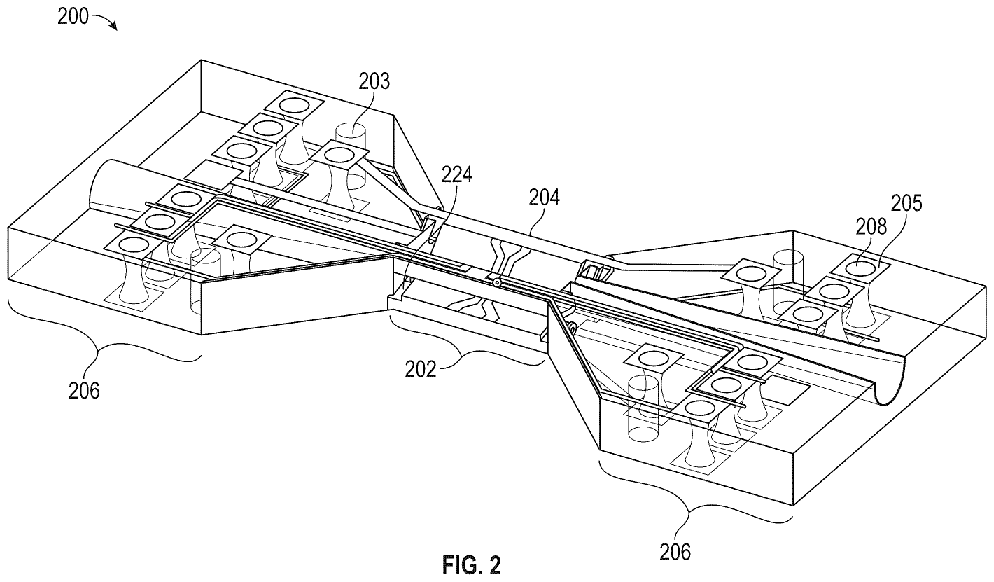

FIG. 2 illustrates the ion trap design in accordance with one or more embodiments. The ion trap design shown in FIG. 2 is fully symmetric relative to all three principal planes of the trap. The ion trap design is a 3D structure that includes four segmented blades 204, that form the ion trap 202, and a surrounding structure 106 that provides mechanical support with mounting holes 203, thermal and electrical interface with the electrical contact pads 205 and trenches 224. All these parts form a single monolithic structure 200. The symmetry of monolithic structure 200 will further improve the performance and the “robustness” of the trapping potential.

Suitable glass materials for the ion trap include silica-based materials such as one or more of amorphous silica, fused quartz, and fused silica. In one or more embodiments, the glass material is fused silica. The glass material may be provided in the form of a substrate, such as a wafer. Other suitable materials include those that are exhibit low electrical field noise, low thermal expansion and low leakage current, and that provide low motional and ion heating rates for the trapped ions for a given ion-electrode distance.

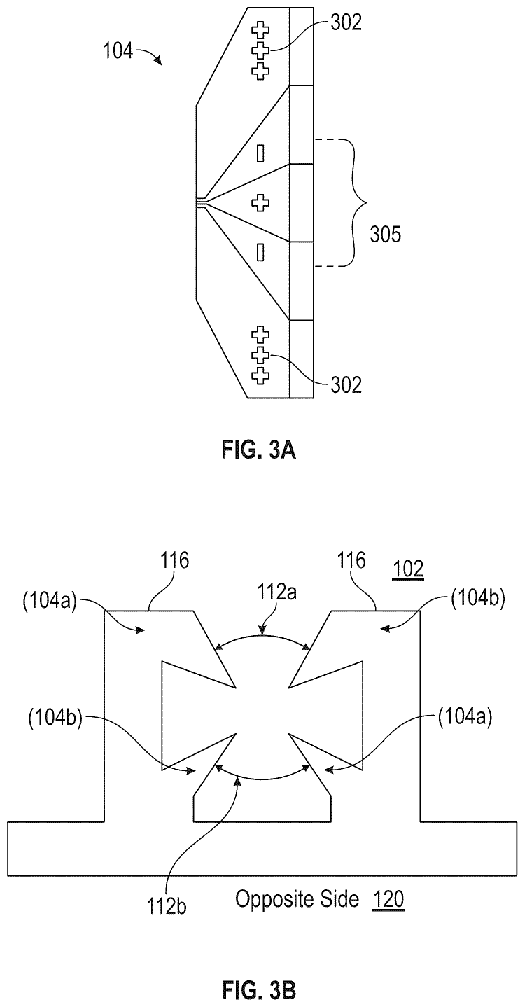

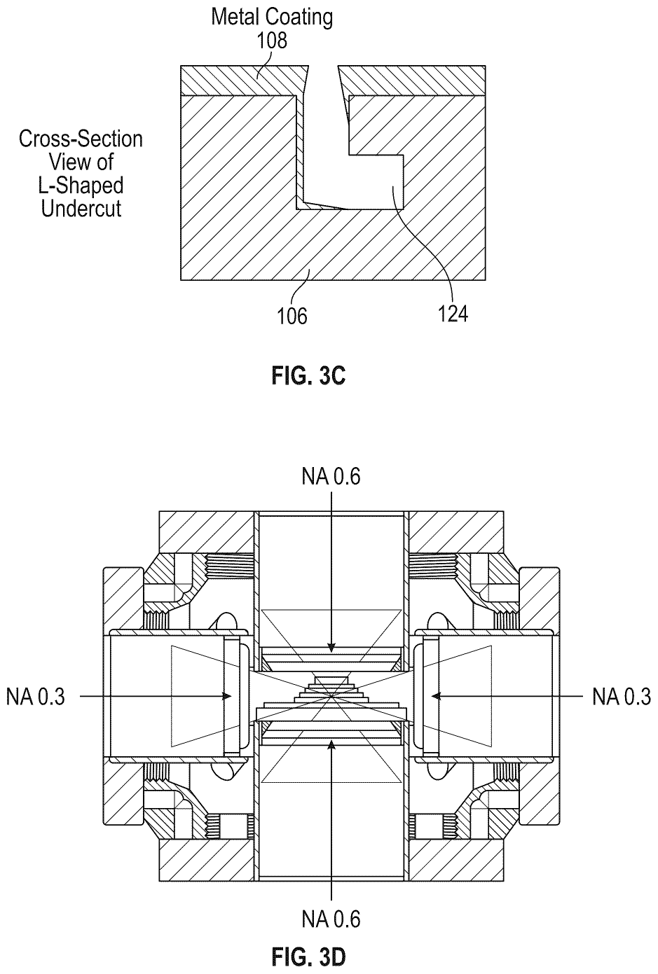

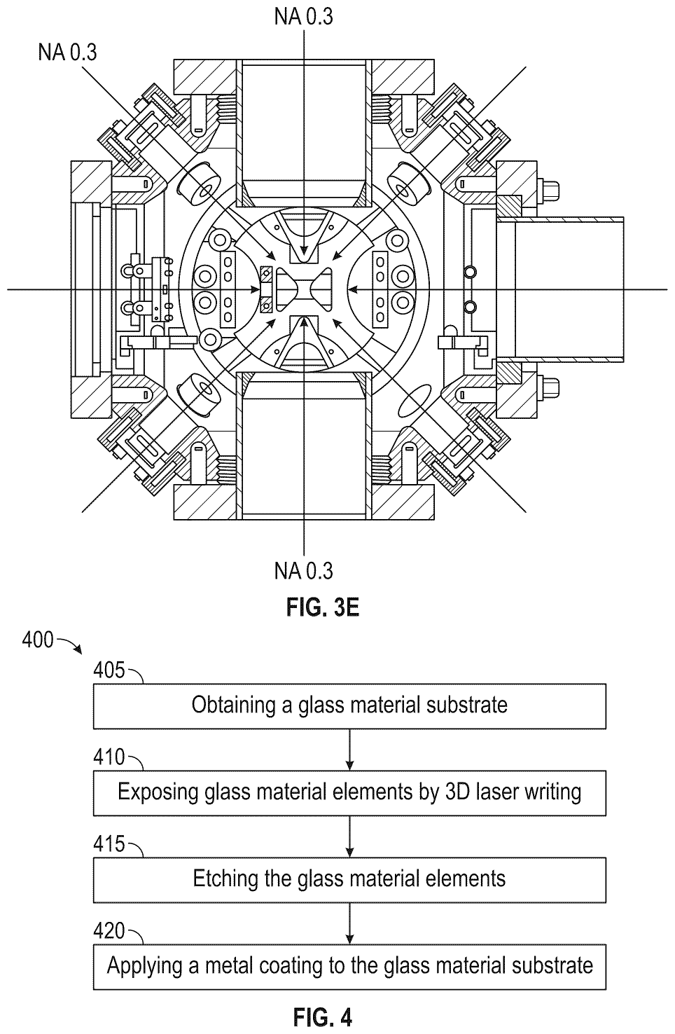

As described above, an ion trap blade includes a plurality of segments. As shown in FIG. 3A, blade 104 may include 5 segments. As shown in FIG. 3A, blade 104 may have a voltage configuration to create a quartic axial potential for the ions. In FIG. 3A, +++ means that there is more positive voltage on the endcaps 302 than on the center electrodes 305. While FIG. 3A shows a configuration of +++, −, +, −, +++, other suitable configurations are envisioned, for example +++, +, −, +. While only 5 segments are shown in FIG. 3A, it is envisioned that the plurality of segments may include more segments that may be used to further improve performance and enable additional functionality like ion shuttling and multiple trapping regions. It is also envisioned that the use of more or less segments and of different sizes (e.g. length) may enable faster and cheaper development for specific tasks. For instance, the length of the 5 segments may be 2285, 250, 150, 250, and 2285 microns. However, more elaborate designs with more segments may further improve performance and enable additional functionality like ion shuttling and multiple trapping regions while simpler designs with less segments may enable faster and cheaper deployment for specific tasks.

In turning to the cross-sectional view of FIG. 3B, the ion trap may include a plurality of segmented blades, such as at least two of a first type blade (104a) and at least two of a second type of blade (104b). According to one of more embodiments, the at least two of a first type of blade are arranged opposite to one another. Further, the at least two of the first type of blade may be grounded. For example, the blades may directly serve as a ground surface for the direct current electrodes or the blades may be indirectly grounded through grounding planes that are separated from blades. The electrodes separated from the ground planes may be connected through large capacitors. The ion trap may include additional grounding planes for shielding and/or reference. While the first type of blades are grounded direct current blades, the second type of blade (104a) may be radio frequency (RF) blades. According to one or more embodiments, the ion trap comprises a total of four blades: two grounded DC blades and two RF blades that carry high rf voltage to generate the quadrupole that forms the effective confining radial potential to trap the ions. The individual segments on the electrodes on the DC blades can be biased independently thereby enabling axial trapping as well as more complicated profiles of the axial confining potential.

In keeping with FIG. 3B, the ion trap may also include a first side 116 and an opposite side 120. On the first side of the ion trap, one of the first type of blade 104a and one of the second type of blade 104b form a first angle 112a. A second angle 112b may also be made on the opposite side of the trap with another of the first type of blade 104a and another of the second type of blade 104b. Further, the angles between the blades enables high optical access in a more compact form. According to one or more embodiments, the ion trap may have an asymmetric blade structure where the first and second angles between the blades are different, such as with angles of 30° and 60°.

Ion-blade separation (the separation between the blades and the geometrical center of the structure where the ion will be trapped) and the shape of the electrodes define several key aspects of the trap functionality such as ion heating rate, trap frequency, and trapping potential uniformity. Thus, these parameters of the ion trap design may be modified depending on the different applications to optimize the uniformity of the axial trapping potential.

Referring again to FIG. 1, the ion trap 102 may be composed of a glass material and a metal coating. As shown in FIG. 3C, the metal coating 108 is adhered to the glass material. The metal coating may be adhered with an adhesion layer between the metal coating and the glass material. Further, the metal coating 108 extends into the trench 124 of the ion trap, which enables electrical separation without exposing the glass material of the trapping region. Every surface that has a direct line of sight to the trapping region (center of the trap) is metal coated and grounded. This includes non-functional surfaces as well as all tunnels and trenches that are embedded in the structure. For instance, the trap may be coated with a layer of gold approximately 2 microns thick. (using an underlayer of titanium for adhesion layer). Different metal coatings, thickness values, which may affect coating stability, conductivity, and probability for shorts may also be used. For instance, in addition to gold, other metal coatings, including but not limited to platinum, gold eutectic alloys (such as gold-palladium) and tungsten may be used.

Further, the electrodes may be separated by a plurality of trenches with trench geometries with low capacitance, such as less than 1 pF. The trenches include undercuts shaped like an “inverted T” or “L”. These trenches with-undercut elements enable electrical separation between adjacent electrodes (or ground plane) without placing uncoated glass surfaces in direct line of site to the trapped ions. The electrodes are defined by the metal coating that is sputtered onto the glass material substrate. The trenches may be optimized to provide electrode separation avoiding the use of 3D masks during the sputtering process. At the same time, the trenches cross section geometries may be designed to enable lower device capacitance which allows for better thermal management and the elimination of electrical shorts.

In turning to the on-side view of FIG. 3D, a vacuum system includes a plurality of viewports. Numerical apertures (NA) shown in FIG. 3D are a geometrical property of the trap. As discussed above, the asymmetric blade structure of the ion trap enables high optical access in a compact form. The trap has high optical access in four orthogonal directions, such as NA=0.6 (top and bottom) and NA=0.3 (left and right). It will be understood as used herein orthogonal directions refers to independent directions.

Turning to FIG. 3E, numerical apertures are included on diagonals between blades such that numerical are possible on all 3 principal axes of the ion trap. According to one or more embodiments, the maximum numerical aperture from the top and bottom of the trap is NA=0.6, from the sides of the trap it is NA=0.3 and there is also a small-NA (0.01<NA<0.1) optical access along the trap axis and with diagonals of up to 45° in the trap plane. It will be understood as used herein high optical access may refer to NA greater than or equal to 0.1, for example NA greater than or equal to 0.2, for example NA greater than or equal to 0.3. In another embodiment, the high numerical apertures are used for high-resolution imaging and the sides of the trap are used for individual ion-addressing. The ion trap may optionally include optical elements that are embedded in the monolithic trap structure such as lenses, fibers, waveguides etc.

As mentioned above in reference to FIG. 1, the trap design includes a surrounding structure 106. The surrounding structure 106 of the ion trap may comprise a mechanical support, a thermal interface, and an electrical interface. The mechanical support includes at least one trench 124 having a trench geometry, as shown in FIG. 2C, mounting holes 103, and electrical contact pads 105. Each electrical contact pad 105 is connected to a specific electrode and positioned on the wide sections of the trap for outside electrical contacts. As shown in FIG. 1, the electrical contact pads may be orientated asymmetrically to connect to the electrical contacts. However, in other embodiments, such as illustrated in FIG. 2, each pad may have a through via 208 which may be used to increase symmetry and to enable one-sided electrical interfaces. The pad layout may be arranged in various configurations to improve (reduce) the total trap capacitance, which will reduce the power consumption and reduce the heat dissipation on the trap, thereby enabling even higher trap frequencies and/or higher drive frequencies. The electrical contact pads may include fuzz buttons or another through hole connector used in the art to make electrical contact and connect electrical components from, for instance, a PCB to an applicable technology.

The above-described technical requirements allow the ion trap to fulfill wide optical access from multiple directions, low heating rates due to large ion-electrode distance, improvements in performance to reach higher trap frequencies and/or higher drive frequencies and the robustness of the trapping potential. Further modifications can be made to improve the trap capacitance, which may also prove to be advantageous for improving manufacturability.

Embodiments disclosed herein are also directed to a method for fabricating the above-described ion trap apparatus. Generally, the trap may be manufactured using a 3D laser writing technique followed by etching of the glass material substrate. The metal coating may be performed by multidirectional sputtering or evaporation.

In one or more embodiments, a method of fabricating the ion trap apparatus 400, as shown in FIG. 4, includes the steps of obtaining a glass material substrate 405, exposing the glass material elements by 3D laser writing the glass material substrate 410, etching the glass material elements 415, and applying a metal coating to the glass material substrate to produce an ion trap apparatus 420, wherein the ion trap apparatus comprises the elements mentioned above.

More specifically, the method is a microfabrication method that uses a selective laser-induced etching process. In the exposing stage 410, the design elements of the trap (e.g. blades and trenches) are written into the glass material substrate with a pulsed femtosecond laser. This process creates an internal stress field and locally changes the properties of the glass material substrate thereby exposing the local glass material elements of the glass material substrate's design. The local exposure of the femtosecond laser light to the elements forms local area volumes of the substrate that are more susceptible to enhanced etching rates relative to the nonlocal areas that are not exposed to the femtosecond laser light. Following the writing on the design elements into the glass material substrate, the exposed local glass material elements are wet-etched according to step 415 to create the 3D shapes of the design. The glass material substrate may be wet-etched in a bath of etching solution such as a solution of hydrofluoric acid (HF), potassium hydroxide (KOH), or other suitable etching solutions.

The wet-etched glass material substrate may then be coated with a metal coating to form the ion trap apparatus. The metal coating may be from 0.01 μm to 20 μm thick. As described above, suitable metal coatings for the ion trap apparatus include gold, other metal coatings, including but not limited to platinum, gold eutectic alloys (such as gold-palladium) and tungsten. The metal coating may be applied using sputtering, evaporation or other physical vapor deposition methods. The method may further include applying an adhesion layer between the glass material and the metal coating of the ion trap apparatus. The adhesion layer may be applied using sputtering or evaporation. The adhesion layer may be applied to the wet-etched glass material substrate before the metal coating. The adhesion layer may include titanium or chromium. The trench design and the global metal coating application allows for adjacent electrodes to remain separated as shown in FIG. 3C.

The above-described method provides improved manufacturability which enables more accurate trap geometries, which leads to cleaner electric potential with better trapping performance. The method also features high precision electrode alignment (±5 μm) such that a manual alignment step may be excluded from the fabrication. It also enables easier and more precise duplication of the ion trap which is advantageous for multi-trap systems needed to build quantum networks.

### EXAMPLES

### Example 1

Different iterations of a monolithic 5-electrode segmented 4-blade ion trap were constructed from a single piece of a fused silica wafer by selective laser-induced chemical etching which enables 3D shaping with micron precision. There are a total of four blades: two are grounded (DC blades) and the other two (RF blades) that carry high rf voltage to generate the quadrupole that forms the effective confining radial potential to trap the ions. Each blade is divided into 5 segments. The trap features an asymmetric blade structure with angles of 30° and 60° between the blades which enables high optical access in a more compact form. The maximum numerical aperture (NA) from the top and bottom of the trap is NA=0.6, from the sides of the trap it is NA=0.3 and there is also small-NA optical access along the trap axis and with diagonals of up to 450 in the trap plane. The coating thickness was 2 μm. The ion-electrode distance is 250 microns and the length of the 5 segments are 2285, 250, 150, 250, and 2285 microns, respectively. Thermal imagining was performed on the ion traps using a thermal camera calibrated to the emissivity of the trap, and was used to characterize the temperature of the trap and its surrounding structure.

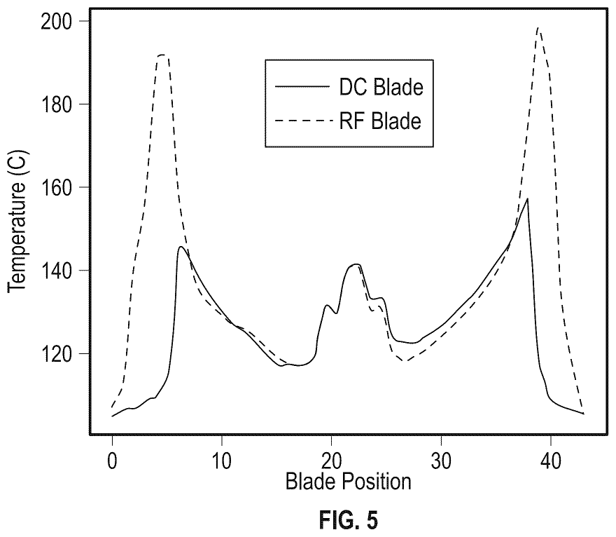

Conventional manufacturing of an ion trap with a metal coating thickness of 2 μm (Vpk=820V and drive frequency f=36 MHz) resulted in significant heat accumulation at the axial ends of the ion trap/surrounding structure, evidenced by visible glowing at the RF/DC electrode gaps when driving at high RF under vacuum. The remaining traps were manufactured by iterating through different coating thicknesses, surface treatments and assembly procedures to improve thermal performance. The traps were heat sinked by an AIN thermal blanket enclosure. The upgraded manufacturing of the ion trap using the method described herein and illustrated in FIG. 4 with a coating thickness of 2 μm resulted in the removal of heat accumulation at axial ends of the blades and showed no heat accumulation at the ion trap center. The upgraded manufacturing thereby allowed for higher peak voltages (Vpk=840V) but lower a lower drive frequency of 35 MHz. With a 2 μm coating thickness, upgraded manufacturing and plasma cleaning, the heat sinking is effective, as shown in FIG. 5, where ions located at the center of the trap has a temperature of approximately 120° C., whereas the surrounding structure at the axial ends the trap are at higher temperatures (˜190-200° C.). More or equal to 2 micron nominal coating thickness with plasma cleaning resulted in the best performance. Further, this process allows for higher drive frequencies (f=37 MHz, Vₚₖ=830V).

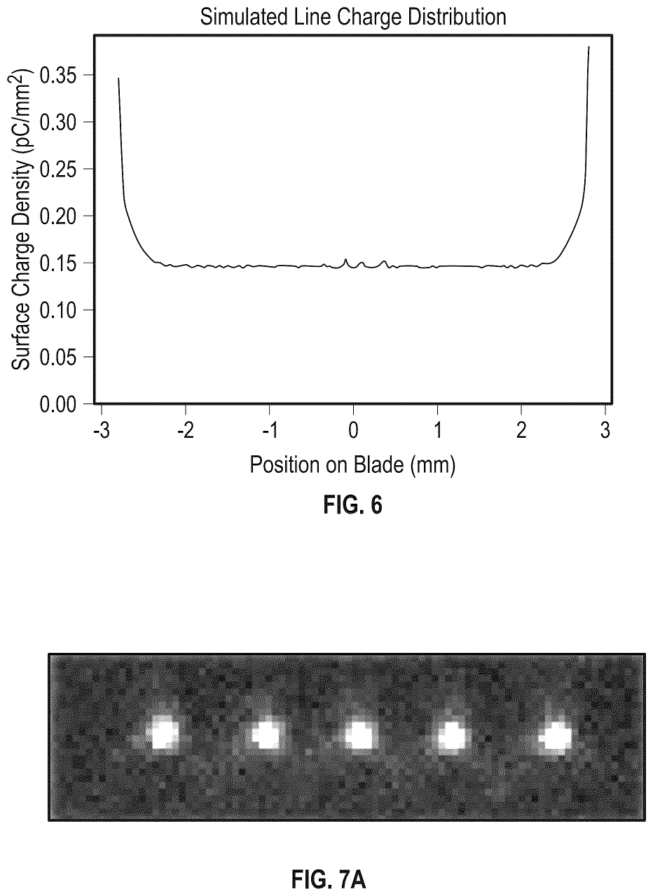

The surface charge distribution of the ion trapped was analyzed using finite-element simulations (COMSOL Multiphysics). As shown in FIG. 6, when IV was applied across the electrodes, areas of high charge (e.g., RF/DC electrode gaps) concentration from the simulation match the areas of high temperature seen at the ends of the trap/surrounding structure from the thermal property testing. The capacitance data from the COMSOL simulations also suggested low capacitance (not shown). Thus, the monolithic ion trap and its properties support the assumption that capacitance is the main contributor to trap heating.

### Example 2

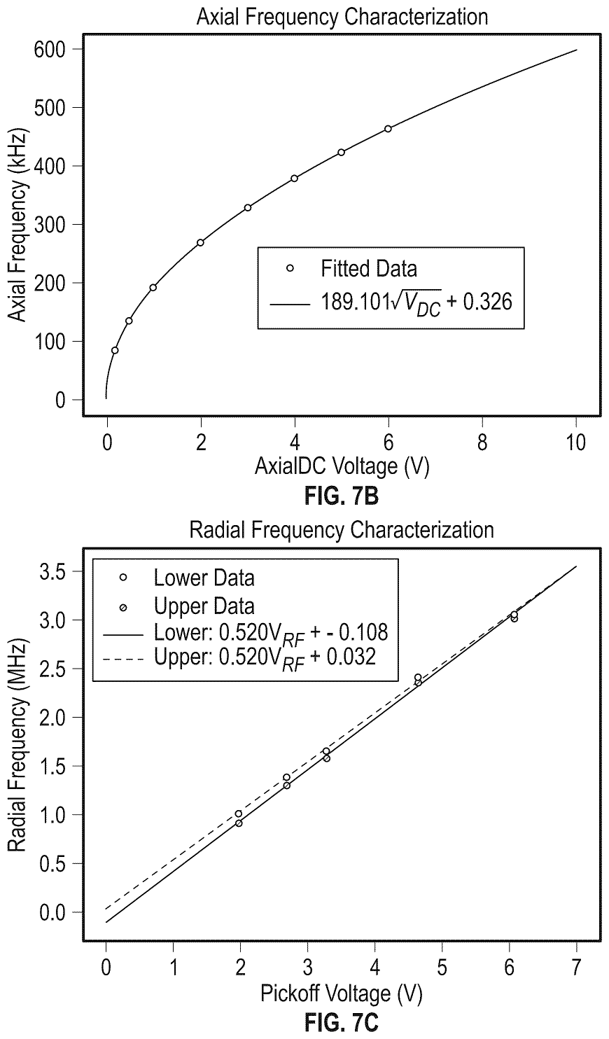

As heavier ions require larger voltages for trapping, the ion trap with a 2 μm coating thickness, upgraded manufacturing and plasma cleaning as described in Ex. 1 was used to trap ytterbium ions. Thus, the ion trap allows for the sufficient trapping of five ytterbium ions as shown in FIG. 7A showing an image of the ion crystal captured with a electron-multiplying charge coupled device (EMCCD). As shown in FIGS. 7B and 7C, the trap frequency of all three principal axes was measured for Ytterbium ions and found to agree very well with the numerical calculations with no fitting parameters. Furthermore, the measured values are relatively high, indicating good performance as compared to the current state-of-the-art blade traps. Ytterbium, being the heaviest ion, proves that for other lighter elements, this trap can deliver even higher trap frequencies with even less heat dissipation while trapping several tens of ions.

### Example 3

A fully symmetric monolithic 5-electrode segmented, 4-blade ion trap was constructed, as shown in FIG. 2., where a ground plane is incorporated and is separated from the electrodes. Here, the DC electrodes were connected to the ground through large capacitors, and additional ground planes for shielding and reference were also added. The ion trap was fully symmetric relative to all three principal planes of the trap to further improve the performance and the “robustness” of the trapping potential. The pad layout was rearranged to improve (reduce) the total trap capacitance, which reduced the power consumption and the heat dissipation on the trap, enabling even higher trap frequencies and/or higher drive frequencies. The pads were connected by through-hole vias to both the top and bottom surfaces which increased the symmetry of the structure.

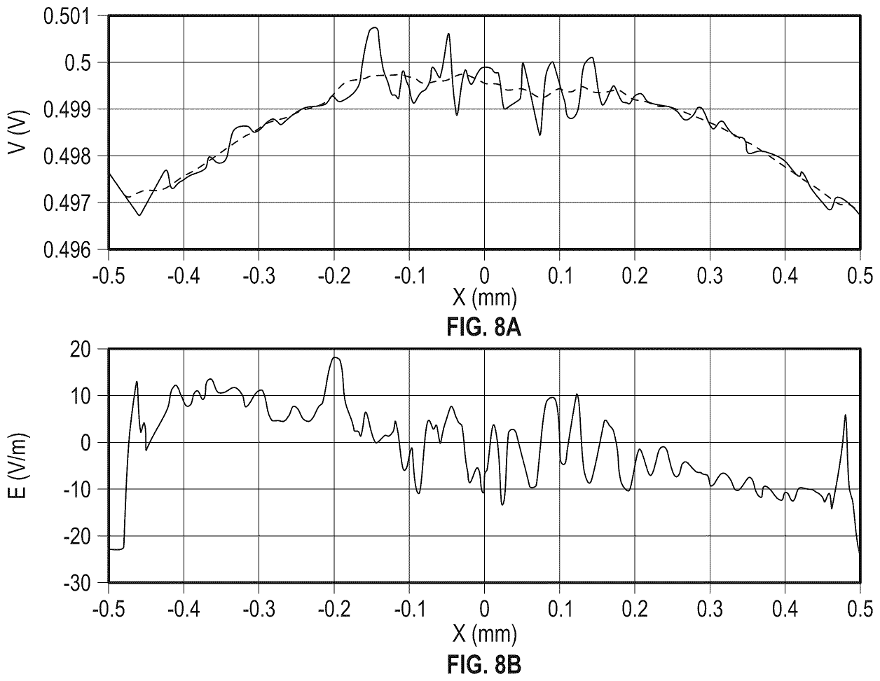

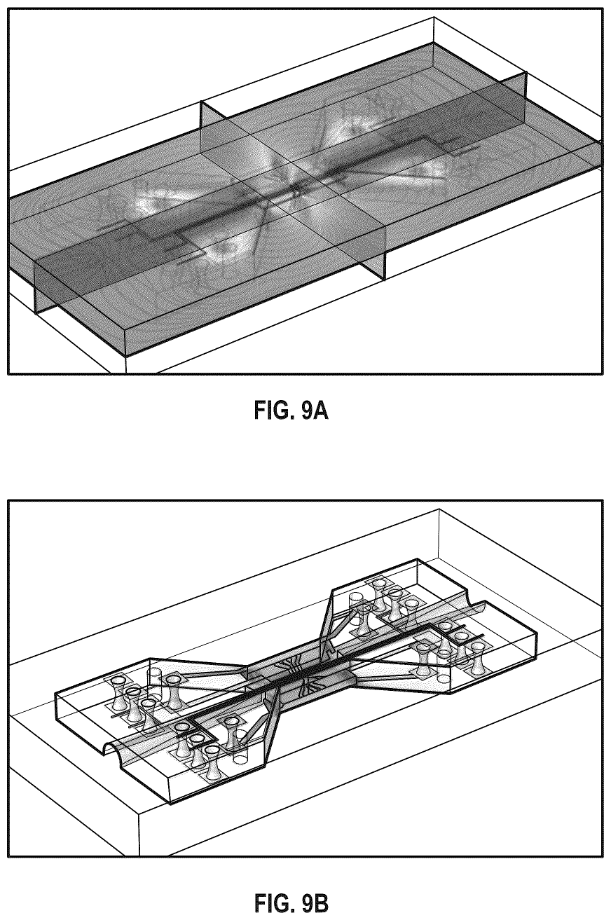

The ion trap was evaluated for its trap potential. As shown in FIGS. 8A and 8B, the electric potential at the central ±250 μm of the trap was less than 1 mV asymmetry, and the axial field was close to zero. FIGS. 9A shows that the electric potential and field lines are symmetric with respect to the trap axis. FIG. 9B show that the surface charge is distributed throughout the trap.

### Example 4

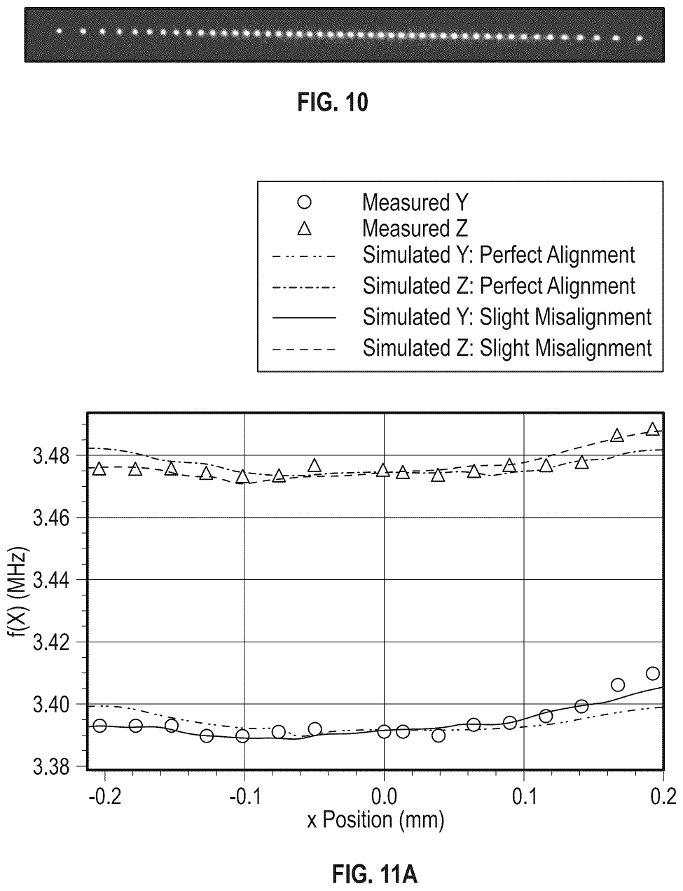

A non-monolithic ion trap was constructed with four blades. The constructed ion trap was then used with a UHV system and an oven to trap Ytterbium ions. Chains of up to ˜50 Yb⁺ ions, lifetime limited by vacuum, were obtained as shown in FIG. 10. A non-monolithic 5-electrode segmented for a quartic axial potential, 4-blade ion trap was constructed to make the ions quasi-uniformly spaced. The segmented blades were manually aligned on an alumina holder. The Finite Element Method (FEM) was used to determine the optimized dimension of the central electrode and was found to be 150 μm.

### Example 5

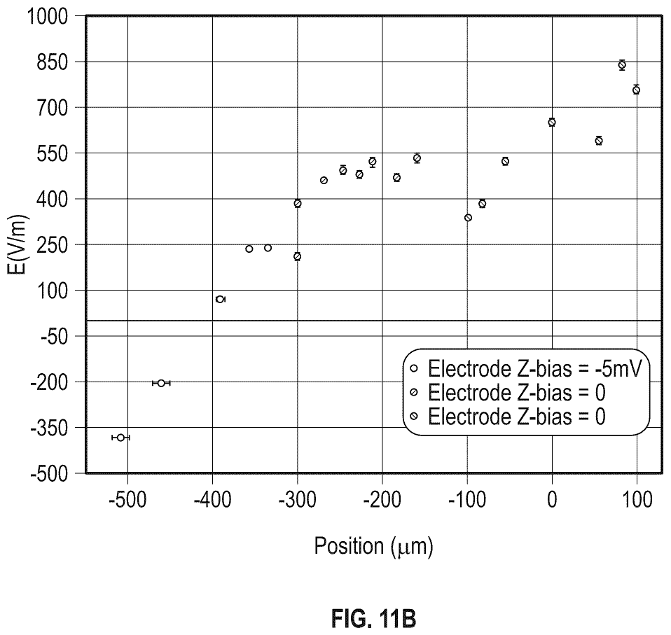

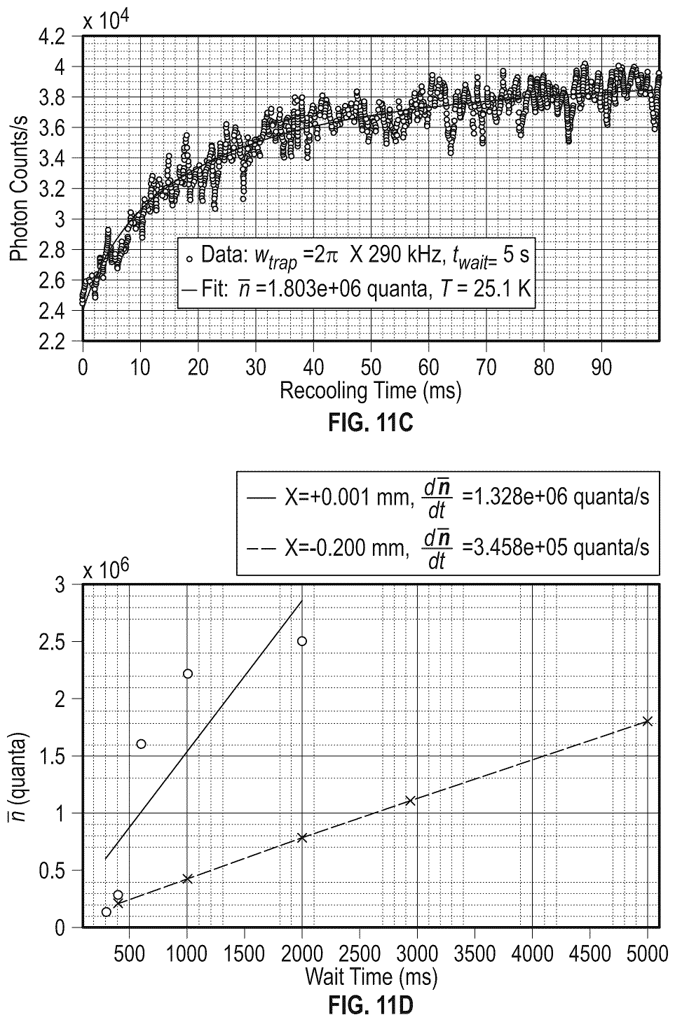

Characteristics of the ion trap of Example 4 were investigated. Uniform axial and radial frequencies were found in a ˜200 μm area at the center of the trap as shown in FIG. 11A. Preliminary results showed high detection fidelity and coherent interactions. The trap was then characterized to determine transverse trap frequencies using a V_{rf} of 400 V and a trap frequency (Ω) of 22 MHz. As shown in FIG. 11A, the transverse trap frequencies varied by less than 25 kHz across the 0.4 mm of the trap center. FEM simulations of the RF blade alignment hinted to tilt on one of the RF blades by 0.2° or both RF blades each by 0.1°.

Photon-correlation spectroscopy between the RF voltage and the fluorescence modulation was used to find the RF null and to observe excess micromotion (EMM). While EMM was able to be eliminated along the transverse directions, the axial EMM position was only minimized when far from the trap center as shown in FIG. 11B. Further, and as shown in FIG. 11C, there was more than 200 V/m residual axial E-field experienced when moving closer to the trap center. Thus, the non-monolithic blade ion trap resulted in a misalignment.

The ion trap was then investigated for its heating rate. Time-resolved fluorescence during Doppler cooling processes after controlled durations of cooling absence was used to estimate the heating rate at different positions along the trap axis. As shown in FIGS. 11C and 11D, the heating rate was high, greater than 10⁵ quanta, when close (+0.001 mm) to the trap center, whereas at the RF null (−0.200 mm), the heating rate was reduced but also high. The heating rate near the center was higher than the X=−0.200 mm due to more RF-induced sideband heating. Further improvements are expected with a monolithic design, such as described in FIGS. 2 and 5-9B, due to better accuracy.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. An ion trap apparatus, comprising:
a three-dimensional, monolithic segmented blade trap with high optical access along four orthogonal directions, comprising;
a plurality of blades wherein each blade comprises,
a glass material; and
a metal coating;
wherein each blade is divided into a plurality of segments.

2. The ion trap apparatus of claim 1, wherein each blade is divided into 5 segments.

3. The ion trap apparatus of claim 1, wherein the plurality of blades further comprises:
at least two of a first type of blade, wherein the first type of blade is a grounded direct current blade; and
at least two of a second type of blade, wherein the second type of blade is a radio frequency blade.

4. The ion trap apparatus of claim 3, wherein one of the first type of blade and one of the second type of blade form a first angle along a trap axis on a first side of the apparatus, and another of the first type of blade and another of the second type of blade form a second angle along the trap axis on an opposite side of the apparatus.

5. The ion trap apparatus of claim 4, wherein the first angle is 30°.

6. The ion trap apparatus of claim 4, wherein the second angle is 60°.

7. The ion trap apparatus of claim 4, having a maximum numerical aperture of 0.6 on the first side of the apparatus.

8. The ion trap apparatus of claim 4, having a maximum numerical aperture of 0.3 on the opposite side of the apparatus.

9. The ion trap apparatus of claim 4, having a small numerical aperture along the trap axis.

10. The ion trap apparatus of claim 1, further comprising optical elements disposed on each blade.

11. The ion trap apparatus of claim 10, wherein the optical elements are one or more selected from a group consisting of lenses, fibers, and waveguides.

12. The ion trap apparatus of claim 1, wherein each blade further comprises an adhesion layer between the glass material and the metal coating.

13. The ion trap apparatus of claim 1, wherein each metal coating comprises gold, gold eutectic alloys, platinum, tungsten, or combinations thereof.

14. The ion trap apparatus of claim 1, wherein ion trap apparatus comprises a plurality of electrodes defined by the metal coating and a plurality of trenches.

15. The ion trap apparatus of claim 1, further comprising:
a surrounding structure, comprising;
a mechanical support further comprising,
a trench having a trench geometry with low capacitance;
mounting holes; and
electrical contact pads;
a thermal interface, and
an electrical interface.
